(19) United States
(12) Patent Application Publication
(10) Pub. No.: US 2011/0199386 A1
(43) Pub. Date: Aug. 18, 2011

(54) OVERLAY FEATURE TO PROVIDE USER ASSISTANCE IN A MULTI-TOUCH INTERACTIVE DISPLAY ENVIRONMENT

(75) Inventors: Pallavi Dharwada, Minneapolis, MN (US); Jason Laberge, New Brighton, MN (US)

(73) Assignee: Honeywell International Inc., Morristown, NJ (US)

(21) Appl. No.: 12/705,026

(22) Filed: Feb. 12, 2010

(51) Int. Cl. G09G 5/02; G09G 5/00

(52) U.S. Cl. 345/592; 345/634; 345/173

(57) ABSTRACT

An example method of displaying items on a touch screen display includes detecting contact with a touch-sensitive display. The method further includes generating a semi-transparent overlay that appears on the display based on the contact with the touch-sensitive display. In other embodiments, the example method includes detecting how many contacts are made with a touch-sensitive display, and generating an overlay that appears on the display, wherein the type of overlay that appears on the display is based on the number of contacts that are made with the touch-sensitive display.

### BACKGROUND

Monitoring large and complex environments is a challenging task for security operators because situations evolve quickly, information is distributed across multiple screens and systems, uncertainty is rampant, decisions can have high risk and far reaching consequences, and responses must be quick and coordinated when problems occur. The increased market present of single-touch and multi-touch interaction devices such as the iPhone, GPS navigators, HP TouchSmart laptop, Microsoft Surface and Blackberry mobile devices offer a significant opportunity to investigate new gesture-based interaction techniques that can improve operator performance during complex monitoring and response tasks.

However, the solutions that are typically incorporated to address the myriad of needs in complex security environments often consist of adding a multitude of features and functions. Unfortunately, one consequence of adding additional features is that operators must remember the features available, including when and how to access them.

### BRIEF DESCRIPTION OF THE DRAWINGS

FIG. 1A illustrates an example touch-sensitive display that shows a semi-transparent overlay after touching the display.

FIG. 1B illustrates the touch-sensitive display of FIG. 1A after a user has executed the gesture path shown on the semi-transparent overlay.

FIG. 2A illustrates an example touch-sensitive display that shows an overlay after a single touch of the display.

FIG. 2B illustrates the touch-sensitive display of FIG. 2A after a user has executed the gesture path shown on the overlay.

FIG. 3A illustrates an example touch-sensitive display that shows an overlay after a dual touch of the display.

FIG. 3B illustrates the touch-sensitive display of FIG. 3A after a user has executed the gesture path shown on the overlay.

FIG. 4A illustrates an example touch-sensitive display that shows an overlay after a simultaneous four touch point contact of the display.

FIG. 4B illustrates the touch-sensitive display of FIG. 3A after a user has executed the gesture path shown on the overlay.

FIG. 5 is a block diagram of an example system for executing the method described herein with reference to FIGS. 1-4.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, electrical, and optical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

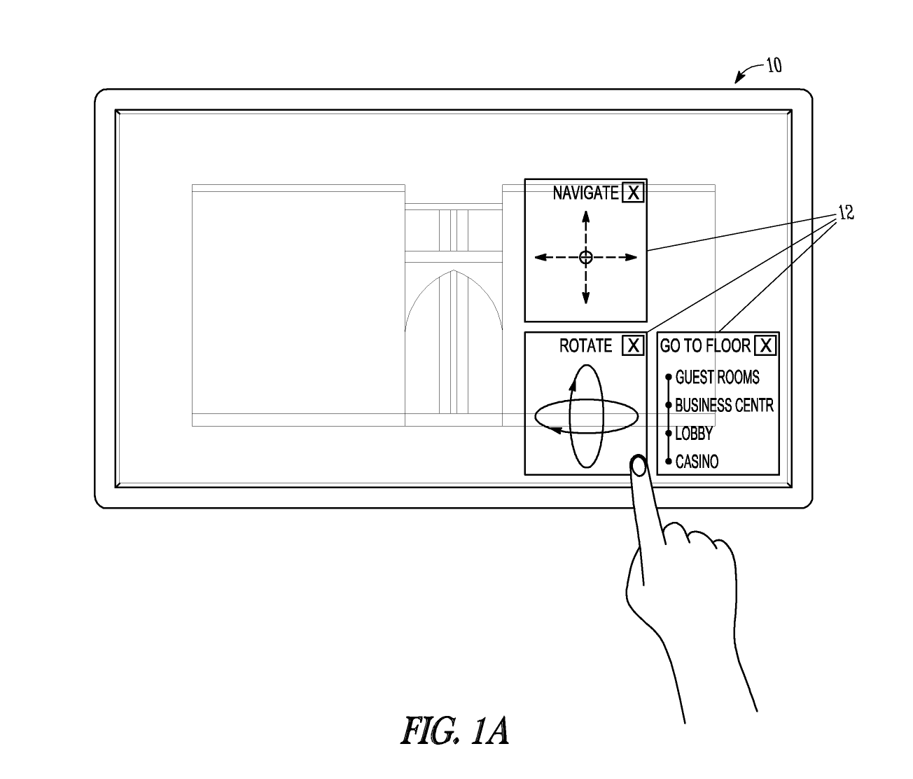

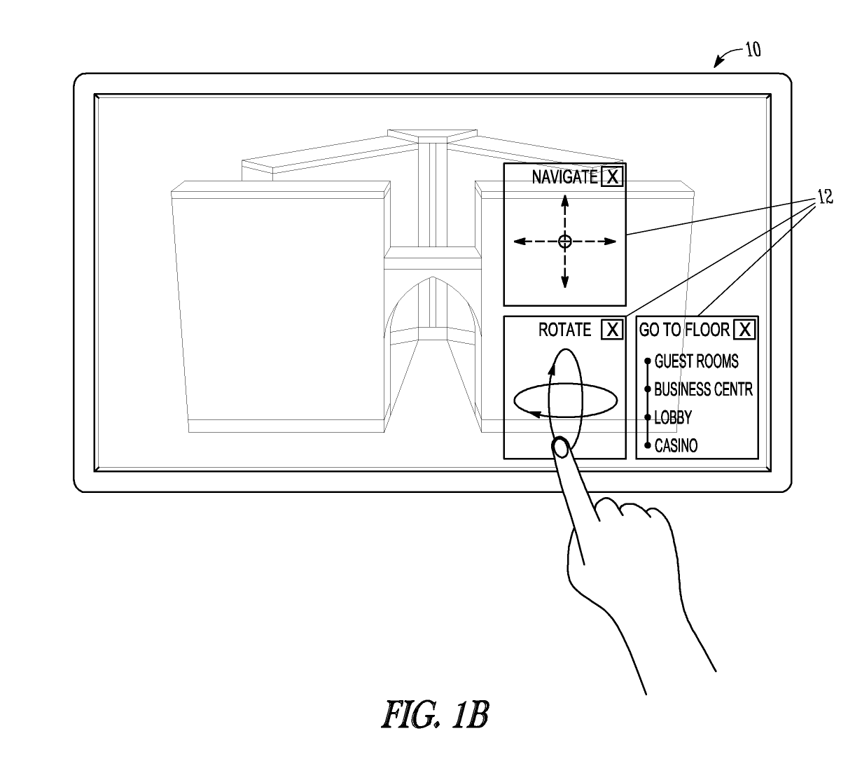

FIGS. 1A-1B illustrate an example method of displaying items on a touch screen display 10. The method includes detecting contact with a touch-sensitive display 10. The method further includes generating a semi-transparent overlay 12 that appears on the display 10 (FIG. 1A) based on the contact with the touch-sensitive display 10.

The semi-transparent overlay(s) 12 described herein may provide memory aiding functions that help users remember the features available at any given time in complex environments. The semi-transparent overlays 12 can show (i) different features or functions available based on the current context; (ii) context-sensitive menu options (similar to a right click function in most desktop applications); (iii) help information (e.g., tooltips, online help, etc.).

In some embodiments, when a semi-transparent overlay 12 shows the available options, it can provide paths that the user can trace with their finger(s) to help users remember the available gestures at any given time (i.e., help users intuitively identify the actions that can be performed on the display 10) or help users access the functions available. The semi-transparent overlay 12 may be context aware in the sense that the gestures or other features shown in each overlay window will vary based on the current situation shown on the display 10 (other options may also be possible). Some examples of context aware situations include (i) information currently shown on the screen (e.g., camera positions and status); (ii) current situation (e.g., normal operations vs. active incident); (iii) features recently assessed (e.g., navigation moves); and/or (iv) last user interaction (e.g., entering data in a form).

It should be noted that any of the semi-transparent overlays 12 can be turned on/off depending on the task situation and/or user preferences (i.e., an expert user may not require the overlay). When gestures are detected as being carried out commensurate with the gesture path shown in the overlay 12, the display 10 shows information in the same manner as if the gesture was completed without the semi-transparent overlay.

One example operation of the method involving the semi-transparent overlay may be described as follows:

1. A user brings hands toward the display 10 and touches one or more points on the surface.

2. The method detects touch points and the touch points remain active based on timing requirements.

3. The method generates a context aware semi-transparent overlay 12 which may be displayed along with corresponding text that indicates the action the overlay 12 affords (see FIG. 1A) that is shown on the display 10. The semi-transparent overlay window 12 may be anchored to the touch point on a corner. The semi-transparent overlay window 12 may show options available in current context. If multiple overlays apply in the current context, they may be arranged in a tiled manner along with appropriate text labels (if text labels are used).

4. The user traces gesture path(s) shown in semi-transparent overlay (see FIG. 1B). Depending on the application where the system and method are used, when gesture tracing begins, the overlay(s) may disappear or be minimized.

In one example embodiment, the semi-transparent overlay window(s) will default to 50% transparency with background color (R:221, G:221, B:221), although other colors and transparencies may be configurable. In addition, the semi-transparent overlay(s) 12 may be anchored to the touch point on a corner. The size of the transparent overlay window may also vary depending on (i) current context (gestures supported); (ii) size of gesture tracing paths; (iii) font size; (iv) display resolution; and (v) display size.

The semi-transparent overlay 12 may provide a visual cue as to where the touch point must start for the gesture trace. As an example, the user may have to move their finger (touch point) to the middle and trace either up/down or left/right. In addition, users may be able to close the semi-transparent overlay 12 by pressing a close button. Gesture paths may be shown as dashed lines with arrows at the end to indicate the direction of tracing for each possible gesture.

If multiple semi-transparent overlays are shown based on the current context, the last one used may be shown anchored to the touch point and act as the primary or active overlay. Additional overlays may be organized in a tiled arrangement starting from the bottom left corner and moving to the right and up (consuming available display real estate as needed).

In some embodiments, as soon as the user starts tracing a gesture path in one of the semi-transparent overlays 12 any other active overlays may disappear. Other embodiments could have the semi-transparent overlay(s) 12 (i) increase in transparency (thus causing them to fade more in the background but not disappear); (ii) reduce to an inactive window (but again not disappear); and/or (iii) stay active (depending on context). In still other embodiments, as soon as the user starts tracing a gesture path in one of the semi-transparent overlays, the active gesture path may change color to provide feedback to the user.

It should be noted that when the user starts tracing a gesture path the system and method may react in the same manner as if the gesture was completed without the semi-transparent overlay 12 and gesture path. As an example, the user may start by touching the center and then tracing the gesture path to the right such that the system and method could react by moving the current view to the right (i.e., the same behavior that would happen if the user completed a left-to-right gesture without the semi-transparent overlay 12).

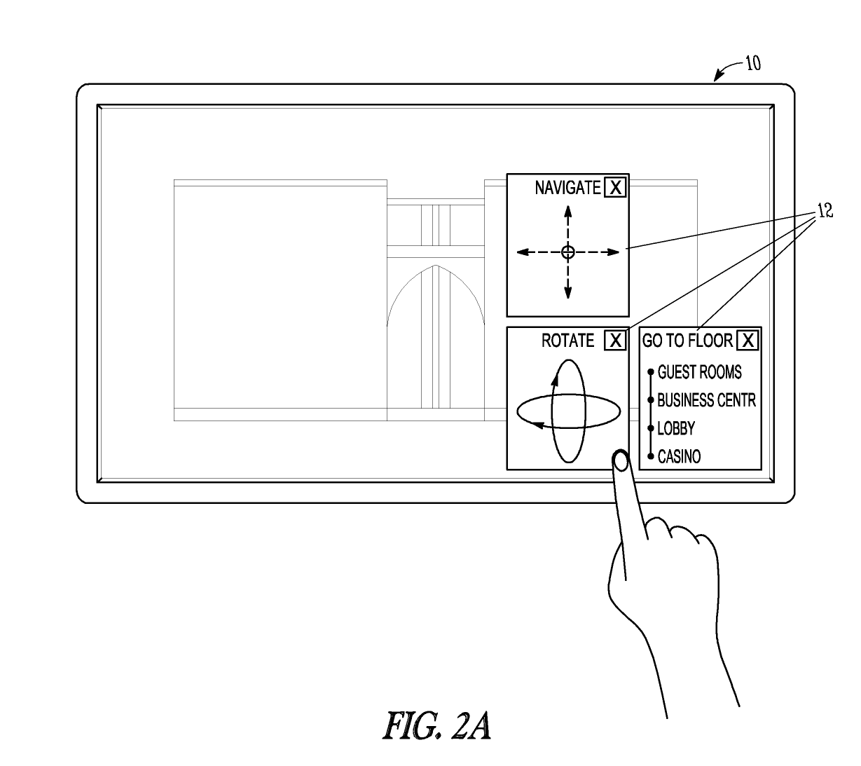

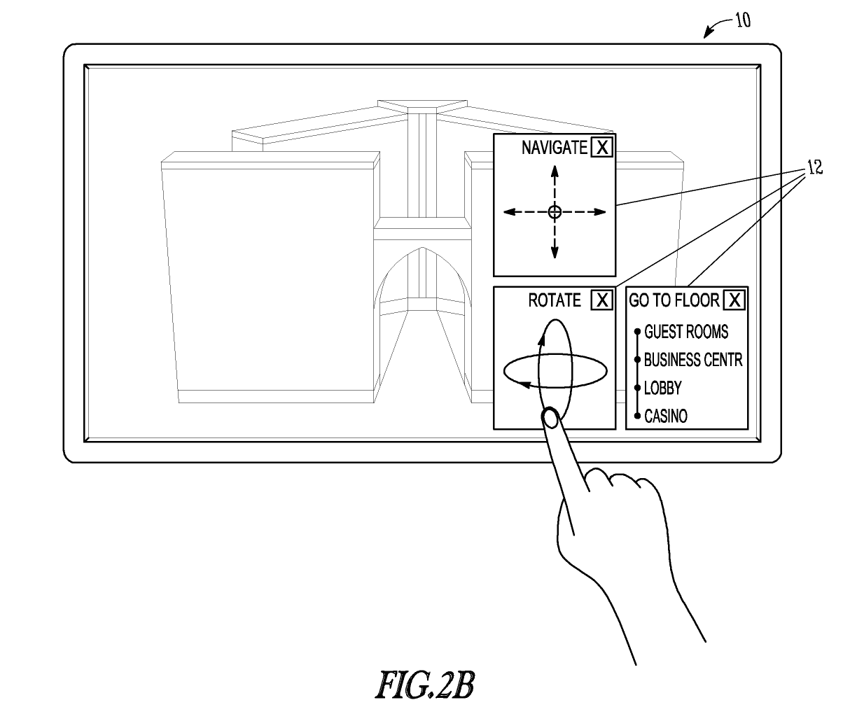

FIGS. 2A-2B illustrate another example method of displaying items on a touch screen display 10. The method includes detecting how many contacts are made with a touch-sensitive display 10. The method further includes generating an overlay 14, 16, 18 that appears on the display 10, wherein the type of overlay 14, 16, 18 that appears on the display 10 is based on the number of contacts that are made with the touch-sensitive display 10 (FIGS. 2A, 3A and 4A).

It should be noted that the number of touch points detected by system may be single finger, multi-finger, multi-hand and multi-user.

Single Touch Point Timing Requirements

In some embodiments, a single touch point may be detected by the unit within a configurable time period (e.g., 1 sec). In addition, the touch point may need to remain active for a minimum configurable amount of time before the overlay is shown (e.g., 250 msecs). The appropriate time requirements will depend on the display platform, sampling rate, and target domain and/or application. When the timing requirements are met, the appropriate context overlay is shown (see FIG. 2A).

Two Touch Point Timing Requirements

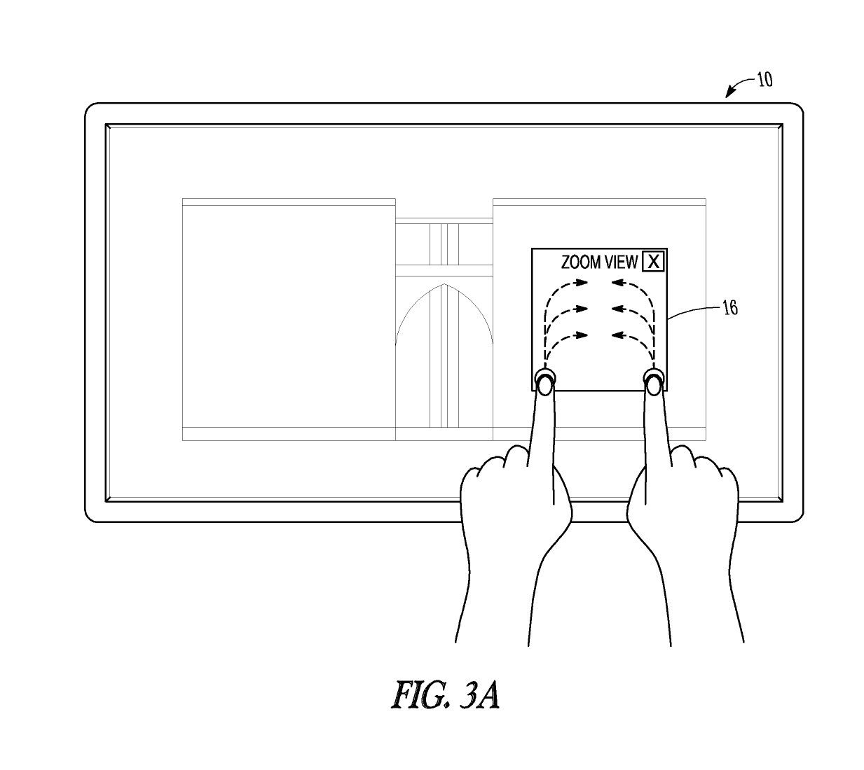

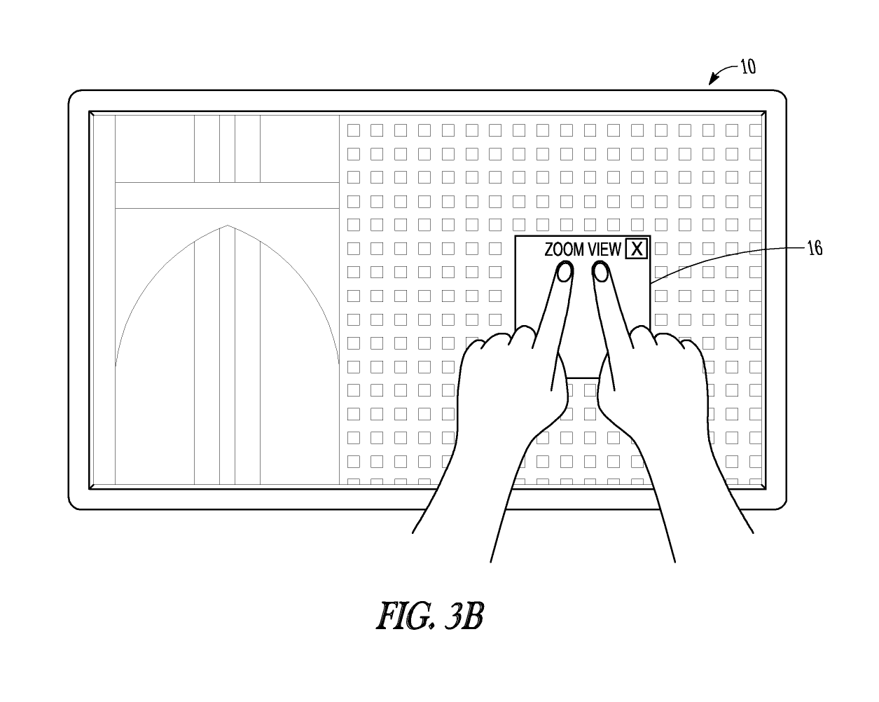

In some embodiments, two touch points must be detected by the unit within a configurable time period (e.g., 1 sec). In addition, both touch points may need to remain active for a minimum configurable amount of time before the overlay is shown (e.g., 250 msecs). The appropriate time requirements will depend on the display platform, sampling rate, and target domain and/or application. When the timing requirements are met, the appropriate dual touch context overlay is shown (see FIG. 3A).

Four Touch Point Timing Requirements

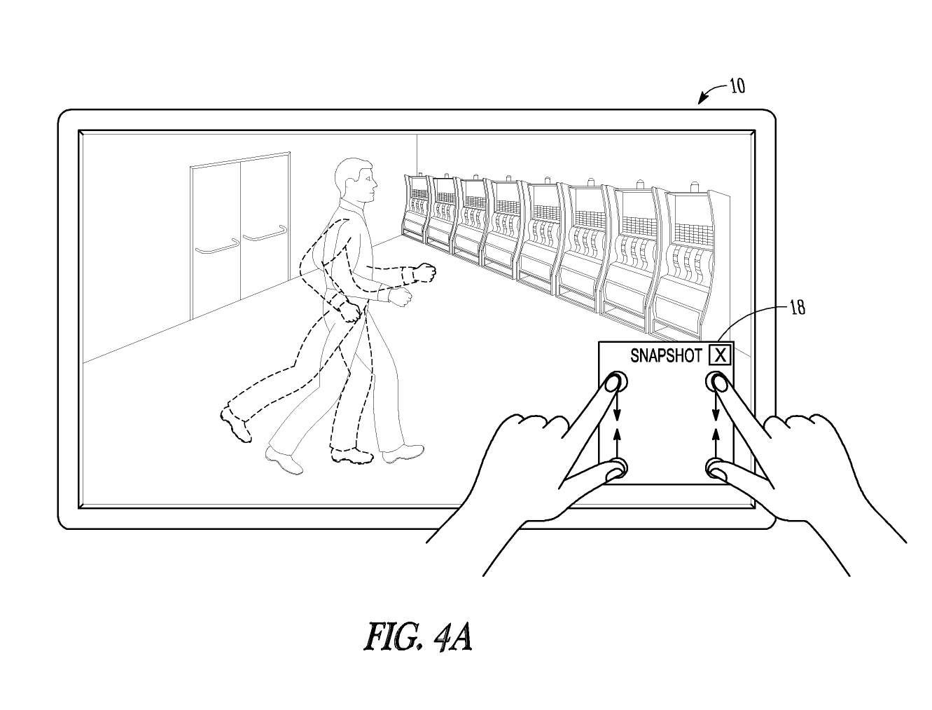

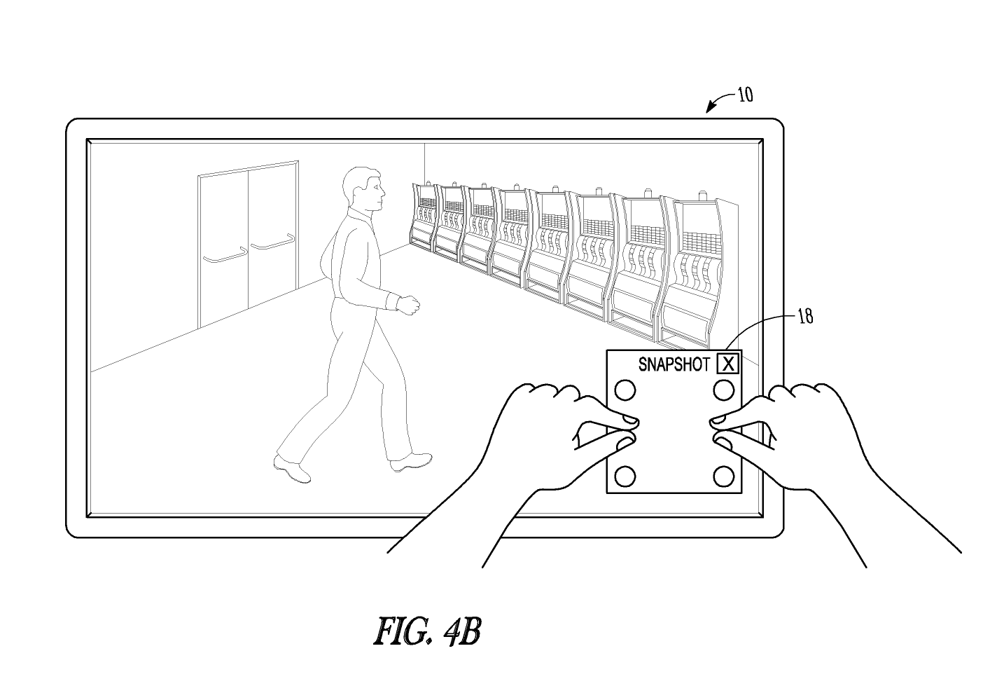

In some embodiments, four touch points must be detected by the unit within a configurable time period (e.g., 1 sec). In addition, all touch points may need to remain active for a minimum configurable amount of time before the overlay is shown (e.g., 250 msecs). The appropriate time requirements will depend on the display platform, sampling rate, and target domain and/or application. When the timing requirements are met, the appropriate four touch context overlay is shown (see FIG. 4A).

One example operation of the method involving an overlay may be described as follows:

1. A user brings hands toward multi-touch display and places one touch point or multiple touch points on the surface. The method detects touch points and they remain active based on timing requirements.

2. The display 10 shows an overlay 14, 16, 18 based on number of touch points detected (FIGS. 2A, 3A and 4A). As an example, an overlay window may be anchored to the touch point on a corner of a window.

3. The overlay window(s) 14, 16, 18 show options that are available in current context for the number of touch points that are detected. If multiple overlays apply in the current context, they may be arranged in a tiled manner.

4. The user traces gesture paths shown in the particular overlay 14, 16, 18 (FIGS. 2B, 3B and 4B). In some embodiments, when gesture tracing begins additional overlays disappear or are minimized.

The user accesses different options by tracing the touch gesture path to select the option they want. When more than one touch point is detected by the system, the overlay shows the gestures and/or options available in the current context. FIGS. 3A-3B shows an example two-fingered navigation options for zooming a current view. FIGS. 4A-4B shows an example four-fingered option for taking a snapshot of the current view on the display 10.

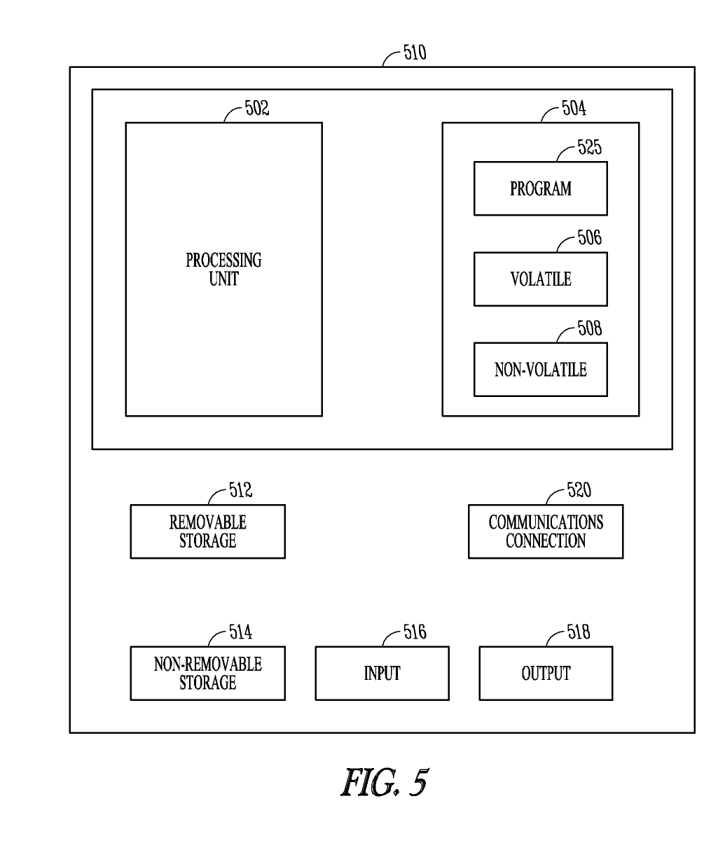

A block diagram of a computer system that executes programming 525 for performing the above method is shown in FIG. 5. The programming may be written in one of many languages, such as virtual basic, Java and others. A general computing device in the form of a computer 510, may include a processing unit 502, memory 504, removable storage 512, and non-removable storage 514. Memory 504 may include volatile memory 506 and non-volatile memory 508. Computer 510 may include—or have access to a computing environment that includes—a variety of computer-readable media, such as volatile memory 506 and non-volatile memory 508, removable storage 512 and non-removable storage 514. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 510 may include or have access to a computing environment that includes input 516, output 518, and a communication connection 520. The input 516 may be a keyboard and mouse/touchpad, or other type of data input device, and the output 518 may be a display device or printer or other type of device to communicate information to a user. In one embodiment, a touch screen device may be used as both an input and an output device.

The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 502 of the computer 510. A hard drive, CD-ROM, and RAM are some examples of articles including a computer-readable medium.

The method described herein may help to provide on-demand assistance to help users know the features and functions available at any given time. The on-demand assistance is a context aware overlay that is activated when the user places at least one finger on the touch-sensitive display. In some embodiments, the overlay is semi-transparent so as not to occlude the critical information shown in the environment that is shown on the display. Showing the overlay may help users remember the features or functions available by reinforcing the options available. The need for an overlay may be reduced with repeated use because users may be more likely to remember the options available and how to use them.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

What is claimed is:

1. A method of displaying items on a touch screen display comprising:
detecting contact with a touch-sensitive display; and
generating a semi-transparent overlay that appears on the display based on the contact with the touch-sensitive display.

2. The method of claim 1, wherein generating a semi-transparent overlay includes generating a semi-transparent overlay having 50% transparency.

3. The method of claim 1, wherein generating a semi-transparent overlay includes generating a plurality of semi-transparent overlays.

4. The method of claim 1, wherein generating a semi-transparent overlay includes generating a semi-transparent overlay that provides paths which a user can trace on the display to perform operations.

5. The method of claim 4, further comprising causing the semi-transparent overlay to disappear once the user traces the paths shown on semi-transparent overlay.

6. A method comprising:
detecting how many contacts are made with a touch-sensitive display; and
generating an overlay that appears on the display, wherein the type of overlay that appears on the display is based on the number of contacts that are made with the touch-sensitive display.

7. The method of claim 6, wherein generating an overlay includes generating a plurality of overlays that appear on the display is based on the number of contacts that are made with the touch-sensitive display.

8. The method of claim 6, wherein generating an overlay includes generating an overlay that provides paths which a user can trace on the display to perform an operation.

9. The method of claim 8, further comprising causing the overlay to disappear once the user traces the paths shown on the overlay.

10. The method of claim 6, wherein detecting how many contacts are made with a touch-sensitive display includes determining how many contacts are made with the display for a minimum amount of time.

11. A system comprising:
a touch-sensitive display; and
a processor to detect contact with a touch-sensitive display and to generate a semi-transparent overlay that appears on the display based on the contact with the touch-sensitive display.

12. The system of claim 11 wherein the processor generates a semi-transparent overlay having 50% transparency.

13. The system of claim 11 wherein the processor generates a plurality of semi-transparent overlays.

14. The system of claim 11 wherein the processor generates a semi-transparent overlay that provides paths which a user can trace on the display to perform operations.

15. The system of claim 14 wherein the processor causes the semi-transparent overlay to disappear once the user traces the paths shown on semi-transparent overlay.

16. A system comprising:
a touch-sensitive display;
a processor to detect contact with a touch-sensitive display and to generate an overlay that appears on the display, wherein the type of overlay that appears on the display is based on the number of contacts that are made with the touch-sensitive display.

17. The system of claim 16 wherein the processor generates a plurality of overlays that appear on the display is based on the number of contacts that are made with the touch-sensitive display.

18. The system of claim 16 wherein the processor generates an overlay that provides paths which a user can trace on the display to perform an operation.

19. The system of claim 16 wherein the processor causes the overlay to disappear once the user traces the paths shown on the overlay.

20. The system of claim 16 wherein the processor determines how many contacts are made with the display for a minimum amount of time.
